(19) United States
(12) Patent Application Publication
(10) Pub. No.: US 2007/0230644 A1
(43) Pub. Date: Oct. 4, 2007

(54) Filtering apparatus

(75) Inventor: Yasunori Yamamoto, Ora-gun (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Osaka (JP)

(21) Appl. No.: 11/728,693

(22) Filed: Mar. 27, 2007

(30) Foreign Application Priority Data
Mar. 29, 2006 (JP) 2006-91507

(51) Int. Cl. H04B 1/10

(52) U.S. Cl. 375/350

(57) ABSTRACT

A data buffer stores both latest and past output data of respective stages. A coefficient buffer stores all coefficients required for each filter processing operation. In first filter processing, a filtering apparatus applies a product-sum operation to input data based on required data read from the data buffer and coefficient buffer. In succeeding filter processing, the filtering apparatus applies a product-sum operation to an output obtained in immediately preceding processing based on required data read from the data buffer and coefficient buffer.

### CROSS-REFERENCE TO RELATED APPLICATIONS

The entire disclosure of Japanese Patent Application No. 2006-091507 including the specification, claims, drawings and abstract is incorporated herein by reference.

### BACKGROUND OF THE INVENTION

1. Field of the Invention

The present invention relates to a filtering apparatus that can apply multistage filter processing to input data.

2. Description of the Related Art

Various filters are conventionally used for various circuits. For example, an audio apparatus includes equalizers for multiple frequency bands to enable a user to individually adjust the intensity of an audio signal in each frequency band. The filtering characteristics of the respective filters can be differentiated for the corresponding frequency bands. Therefore, an audio signal having desired frequency characteristics can be obtained.

If a filtering apparatus processes a digital audio signal, a digital analog converter (DAC) is required to apply conventional analog processing to digital audio data, and the circuit scale tends to become larger. Therefore, a digital filter can be preferably used to apply digital signal processing to digital audio data, as discussed in JP 2003-179466 A.

If a frequency band is finely divided for multiple equalizers; e.g., when the frequency band is divided into eight bands, a total of eight filtering circuits are required. As a result, the circuit scale becomes larger.

If a filtering apparatus includes a digital signal processor (DSP) that can perform software processing, the circuit scale will become larger for the DSP.

### SUMMARY OF THE INVENTION

The present invention can realize multistage filter processing using a single filter that can selectively provide set values and coefficients.

### BRIEF DESCRIPTION OF THE DRAWINGS

The accompanying drawings, which are incorporated in and constitute a part of the specification, illustrate an embodiment of the invention and, together with the description, serve to explain the principles of the invention, in which:

FIG. 1 illustrates a filtering apparatus according an embodiment of the present invention;

FIG. 2 illustrates a circuit arrangement for a filtering apparatus according to an embodiment of the present invention;

FIG. 3 illustrates a filtering apparatus according an embodiment of the present invention; and

FIG. 4 illustrates a filtering apparatus according an embodiment of the present invention.

### DESCRIPTION OF PREFERRED EMBODIMENTS

Embodiments of the present invention will be described with reference to the drawings.

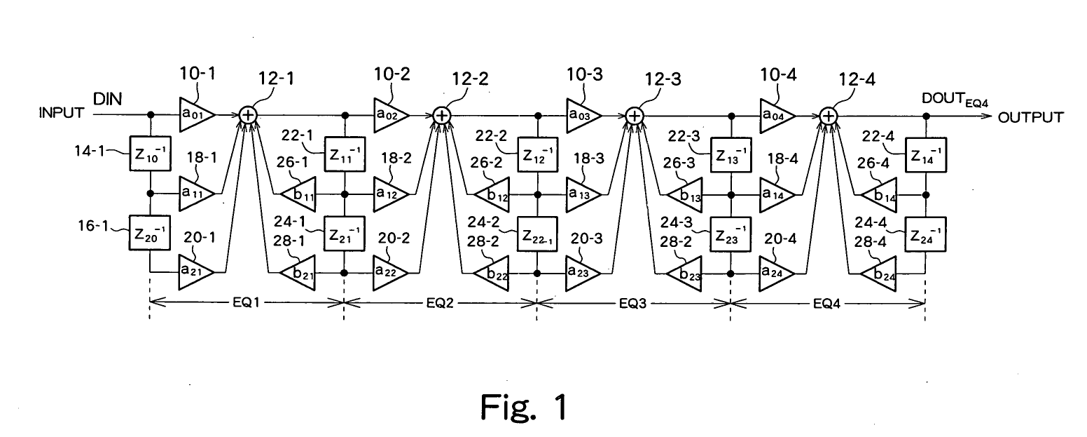

FIG. 1 is an equivalent circuit illustrating equalizer processing performed by a filtering apparatus according an embodiment of the present invention.

A multiplier 10-1 multiplies an input signal DIN (e.g., a PCM signal) by a coefficient a₀₁. An adder 12-1 receives an output of the multiplier 10-1. A delay circuit 14-1 stores a previous value (Z₁₀⁻¹) of the input signal DIN (i.e., 1-clock delayed input signal DIN). Furthermore, a delay circuit 16-1 stores a previous output (Z₂₀⁻¹) of the delay circuit 14-1 (i.e., 2-clock delayed input signal DIN). A multiplier 18-1 multiplies an output of the delay circuit 14-1 by a coefficient all. A multiplier 20-1 multiplies an output of the delay circuit 16-1 by a coefficient a₂₁. The adder 12-1 receives an output of the multiplier 18-1 and an output of the multiplier 20-1. Accordingly, the output Z₁₀⁻¹ of the delay circuit 14-1 is equal to the 1-clock delayed input signal DIN. The output Z₂₀⁻¹ of the delay circuit 16-1 is equal to the 2-clock delayed input signal DIN.

A delay circuit 22-1 stores a previous output value (Z₁₁⁻¹) of the adder 12-1 (i.e., 1-clock delayed output of the adder 12-1). Furthermore, a delay circuit 24-1 stores a previous output value (Z₂₁⁻¹) of the delay circuit 22-1 (i.e., 2-clock delayed output of the adder 12-1). A multiplier 26-1 multiplies an output of the delay circuit 22-1 by a coefficient b₁₁. A multiplier 28-1 multiplies an output of the delay circuit 24-1 by a coefficient b₂₁. The adder 12-1 receives an output of the multiplier 26-1 and an output of the multiplier 28-1. Accordingly, the output Z₁₁⁻¹ of the delay circuit 22-1 is equal to the 1-clock delayed output of the adder 12-1. The output Z₂₁⁻¹ of the delay circuit 24-1 is equal to the 2-clock delayed output of the adder 12-1.

Through the above-described processing, the adder 12-1 produces an output signal of a 1st-stage equalizer EQ1 and supplies the produced signal to a 2nd-stage equalizer EQ2.

Similar processing is performed in each of succeeding stages. Each equalizer inputs an output signal of the adder in the immediate preceding equalizer. In general, an input signal of n-th stage equalizer EQn is equal to an output signal of the adder 12-n in an immediate preceding equalizer EQn-1, where n is a number assigned to an equalizer EQn.

Namely, an equalizer EQn inputs an output DOUT_{EQn-1}(0) of an immediately preceding equalizer EQn-1. In the immediately preceding equalizer EQn-1, two delay circuits 22-(n−1) and 24-(n−1) are provided at the output side. The delay circuit 22-(n−1) sets DOUT_{EQn-1}(−1) which is equal to a 1-clock delayed input signal, and the delay circuit 24-(n−1) sets DOUT_{EQn-1}(−2) which is equal to a 2-clock delayed input signal. In the equalizer EQn, the delay circuit 22-n sets DOUT_{EQn}(−1) which is equal to a 1-clock delayed output signal and the delay circuit 24-n sets DOUT_{EQn}(−2) which is equal to a 2-clock delayed output signal.

The filtering apparatus of the present embodiment performs the following calculations for first to fourth equalizers illustrated in FIG. 1.

The first-stage equalizer produces an output DOUT_{EQ1}=(DIN·a₀₁)+(Z₁₀⁻¹·a₁₁)+(Z₂₀⁻¹·a₂₁)+(Z₁₁⁻¹·b₁₁)+(Z₂₁⁻¹·b₂₁), where Z₁₀⁻¹ is equal to a 1-clock delayed DIN, Z₂₀⁻¹ is equal to a 2-clock delayed DIN, Z₁₁⁻¹ is equal to a 1-clock delayed DOUT_{EQ1}, and Z₂₁⁻¹ is equal to a 2-clock delayed DOUT_{EQ1}.

The second-stage equalizer produces an output DOUT_{EQ2}=(DOUT_{EQ1}·a₀₂)+(Z₁₁⁻¹·a₁₂)+(Z₂₁⁻¹·a₂₂)+(Z₁₂⁻¹·b₁₂)+(Z₂₂⁻¹·b₂₂), where Z₁₁⁻¹ is equal to a 1-clock delayed DOUT_{EQ1}, Z₂₁⁻¹ is equal to a 2-clock delayed DOUT_{EQ1}, Z₁₂⁻¹ is equal to a 1-clock delayed DOUT_{EQ2}, and Z₂₂⁻¹ is equal to 2-clock delayed DOUT_{EQ2}.

The third-stage equalizer produces an output DOUT_{EQ3}=(DOUT_{EQ2}·a₀₃)+(Z₁₂⁻¹·a₁₃)+(Z₂₂⁻¹·a₂₃)+(Z₁₃⁻¹·b₁₃)+(Z₂₃⁻¹·b₂₃), where Z₁₂¹ is equal to a 1-clock delayed DOUT_{EQ2}, Z₂₂¹ is equal to a 2-clock delayed DOUT_{EQ2}, Z₁₃⁻¹ is equal to a 1-clock delayed DOUT_{EQ3}, and Z₂₃⁻¹ is equal to a 2-clock delayed DOUT_{EQ3}.

The fourth-stage equalizer produces an output DOUT_{EQ4}=(DOUT_{EQ3}·a₀₄)+(Z₁₃⁻¹·a₁₄)+(Z₂₃⁻¹·a₂₄)+(Z₁₄⁻¹·b₁₄)+(Z₂₄⁻¹·b₂₄), where Z₁₃⁻¹ is equal to a 1-clock delayed DOUT_{EQ3}, Z₂₃⁻¹ is equal to a 2-clock delayed DOUT_{EQ3}, Z₁₄⁻¹ is equal to a 1-clock delayed DOUT_{EQ4}, and Z₂₄⁻¹ is equal to a 2-clock delayed DOUT_{EQ4}.

The present embodiment does not use four equalizers to realize the filter processing illustrated in FIG. 1. Rather, the present embodiment uses only one equalizer to successively perform the aforementioned processing for the first to fourth equalizers.

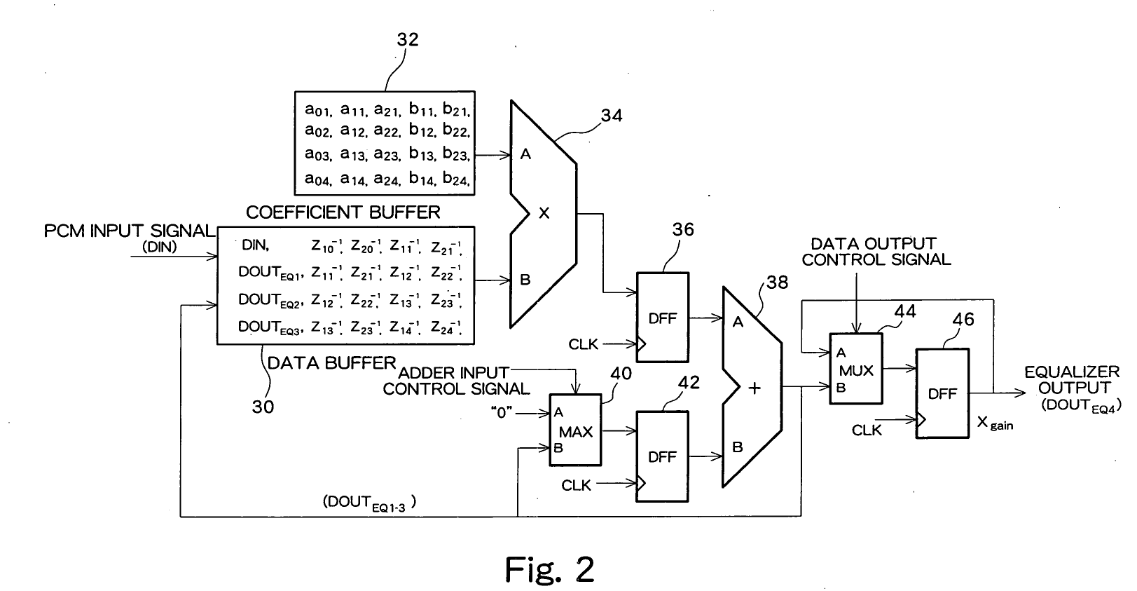

FIG. 2 illustrates an arrangement of a filtering apparatus according to a preferred embodiment. A data buffer 30 inputs an input signal DIN. The data buffer 30 stores input and output data in the preceding processing as well as previous input and output data stored in the delay circuits.

For example, the 1st-stage processing requires DIN, Z₁₀⁻¹, Z₂₀⁻¹, Z₁₁⁻¹, and Z₂₁⁻¹. When a present DIN is DIN(0), an output DOUT_{EQ1}(0) can be calculated if DIN(−1), DIN(−2), DOUT_{EQ1}(−1), and DOUT_{EQ1}(−2) are known. Hence, the data buffer 30 stores present and preceding input and output signals for the equalizers of respective stages. Thus, the data buffer 30 can store Z₁₀⁻¹, Z₂₀⁻¹, Z₁₁⁻¹, and Z₂₁⁻¹ for the 1st-stage equalizer.

Furthermore, a coefficient buffer 32 stores coefficients a₀ₙ, a₁ₙ, a₂ₙ, b₁ₙ, and b₂ₙ (n=1 to 4 according to the example illustrated in FIG. 2) for each-stage equalizer.

An output of the data buffer 30 and an output of the coefficient buffer 32 are supplied to a multiplier 34. For example, in the first filter processing, the data buffer 30 outputs DIN and the coefficient buffer 32 outputs a coefficient a₀₁. The multiplier 34 produces an output (DIN·a₀₁). A flip-flop circuit 36 can input the output (DIN·a₀₁) of the multiplier 34 in synchronism with a clock signal CLK.

An output of the flip-flop circuit 36 is supplied to an adder 38. An output of the adder 38 can be supplied to an input terminal of the adder 38 via a multiplexer 40 and a flip-flop circuit 42 that can input a signal in synchronism with a clock signal CLK. The multiplexer 40 can select “0” or an output of the adder 38 according to an adder input control signal. Accordingly, if the multiplexer 40 selects an output of the adder 38, the output of the adder 38 can be added to a new output of the multiplier 34.

In other words, the filtering apparatus according to the present embodiment can perform an accumulative calculation by successively adding the output of the adder 38 to a new output of the multiplier 34. Hence, the data buffer 30 successively outputs DIN, Z₁₀⁻¹, Z₂₀⁻¹, Z₁₁⁻¹, and Z₂₁⁻¹, while the coefficient buffer 32 successively outputs a₀₁, a₁₁, a₂₁, b₁₁, and b₂₁. Through the above-described sequential multiplicative and additive processing, the adder 38 can produce an output DOUT_{EQ1}=(DIN·a₀₁)+(Z₁₀⁻¹·a₁₁)+(Z₂₀⁻¹·a₂₁)+(Z₁₁⁻¹·b₁₁)+(Z₂₁⁻¹·b₂₁) at the fourth output timing.

When the above-described calculation processing for the first equalizer is completed, the obtained DOUT_{EQ1} is supplied to the data buffer 30. Then, the second filter processing is performed to calculate DOUT_{EQ2}. More specifically, the data buffer 30 successively outputs DOUT_{EQ1}, Z₁₁⁻¹, Z₂₁⁻¹, Z₁₂⁻¹, and Z₂₂⁻¹ and the coefficient buffer 32 successively output a₀₂, a₁₂, a₂₂, b₁₂, and b₂₂. Through the above-described multiplicative and additive processing, the adder 38 can produce an output DOUT_{EQ2}=(DOUT_{EQ1}·a₀₂)+(Z₁₁⁻¹·a₁₂)+(Z₂₁⁻¹·a₂₂)+(Z₁₂⁻¹·b₁₂)+(Z₂₂⁻¹·b₂₂). The obtained DOUT_{EQ2} is stored in the data buffer 30.

Furthermore, in the third filter processing, the filtering apparatus according to the present embodiment can produce an output DOUT_{EQ3}=(DOUT_{EQ2}·a₀₃)+(Z₁₂⁻¹·a₁₃)+(Z₂₂⁻¹·a₂₃)+(Z₁₃⁻¹·b₁₃)+(Z₂₃⁻¹·b₂₃). The obtained DOUT_{EQ3} is stored in the data buffer 30. In the fourth filter processing, the filtering apparatus according to the present embodiment can produce an output DOUT_{EQ4}=(DOUT_{EQ3}·a₀₄)+(Z₁₃⁻¹·a₁₄)+(Z₂₃⁻¹·a₂₄)+(Z₁₄¹·b₁₄)+(Z₂₄⁻¹·b₂₄). The obtained DOUT_{EQ4} is stored in the data buffer 30. Thus, the filtering apparatus finally produces an output equal to DOUT_{EQ4}.

A flip-flop circuit 46 can input an output of the adder 38 via a multiplexer 44 in synchronism with a clock signal CLK. The multiplexer 44 selects an output of the adder 38 or an output of the flip-flop circuit 46 based on a data output control signal. The data output control signal is controlled so that the multiplexer 44 can select an output of the adder 38 at the timing the above-described sequential filter processing for first to fourth equalizers. Accordingly, the filtering apparatus illustrated in FIG. 2 can successively produce DOUT_{EQ4} from the flip-flop circuit 44 each time the four-stage filter processing is completed.

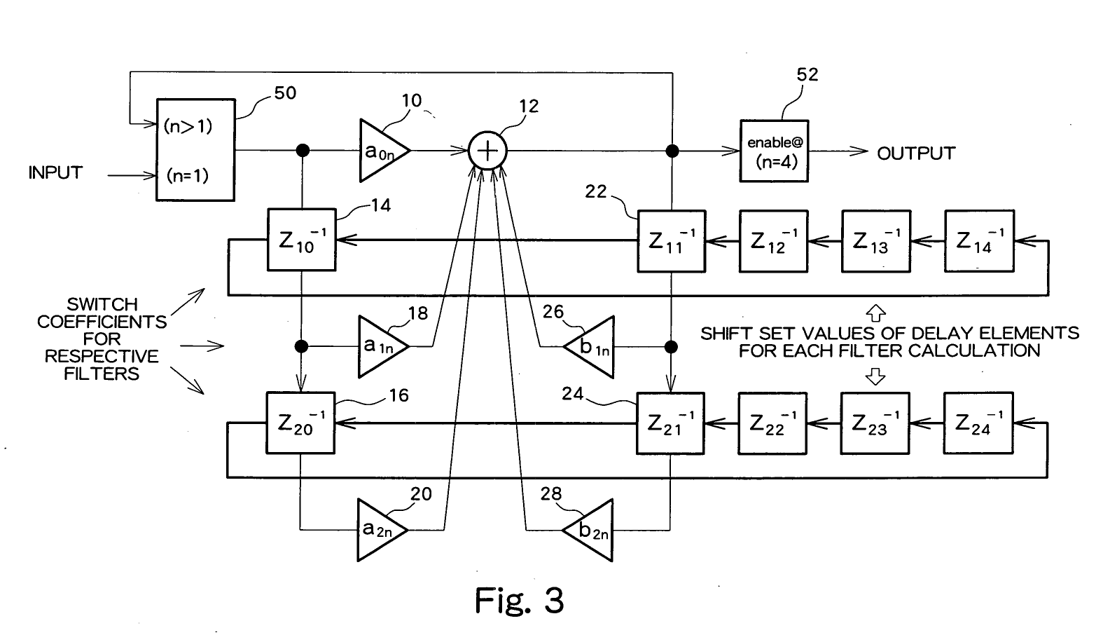

FIG. 3 illustrates hardware elements required for single filter processing according to an embodiment of the present invention, which is comparable to the arrangement illustrated in FIG. 1.

According to the arrangement illustrated in FIG. 3, data DIN is input to a multiplexer 50. An output of an adder 12 is also input to the multiplexer 50. The multiplexer 50 selects DIN in the first filter processing (n=1) and selects an output of the adder 12 in the succeeding filter processing (n>1); i.e., DOUT_{EQ1} in the second filter processing, DOUT_{EQ2} in the third filter processing, and DOUT_{EQ3} in the fourth filter processing.

The adder 12 can produce an output via a gate 52 which opens only in the final (i.e., fourth) filter processing (n=4). Therefore, the filtering apparatus according to the present embodiment can produce an output DOUT_{EQ4} from the gate 52 through the fourth-stage filter processing. If necessary, the circuit can produce DOUT_{EQ1}, or DOUT_{EQ2}, or DOUT_{EQ3} from the gate 52.

Delay circuits 14, 16, 22, and 24 are capable of arbitrarily shifting set values. More specifically, the set values in the delay circuits 14 and 22 are Z₁₀⁻¹ and Z₁₁⁻¹ in the first filter processing, Z₁₁⁻¹ and Z₁₂⁻¹ in the second filter processing, Z₁₂⁻¹ and Z₁₃⁻¹ in the third filter processing, and Z₁₃⁻¹ and Z₁₄⁻¹ in the fourth filter processing. Hence, as illustrated in FIG. 3, the filtering apparatus according to the present embodiment includes a barrel shifter that can successively shift the values Z₁₀⁻¹, Z₁₁⁻¹, Z₁₂⁻¹, Z₁₃⁻¹, and Z₁₄⁻¹ which are prepared beforehand.

The set values in the delay circuits 16 and 24 are Z₂₀⁻¹ and Z₂₁⁻¹ in the first filter processing, Z₂₁⁻¹ and Z₂₂⁻¹ in the second filter processing, Z₂₂⁻¹ and Z₂₃⁻¹ in the third filter processing, and Z₂₃⁻¹ and Z₂₄⁻¹ in the fourth filter processing. Hence, as illustrated in FIG. 3, the filtering apparatus according to the present embodiment includes a barrel shifter that can successively shift the values Z₂₀⁻¹, Z₂₁⁻¹, Z₂₂⁻¹, Z₂₃⁻¹, and Z₂₄⁻¹ which are prepared beforehand.

The values Z₁₀⁻¹, Z₁₁⁻¹, Z₁₂⁻¹, Z₁₃⁻¹, and Z₁₄⁻¹ are obtained in the immediately preceding processing, where Z₁₀⁻¹ is equal to input data DIN(−1), Z₁₁⁻¹ is equal to an output DOUT_{EQ1}(−1) of the 1st-stage equalizer, Z₁₂⁻¹ is equal to an output DOUT_{EQ2}(−1) of the 2nd-stage equalizer, Z₁₃⁻¹ is equal to an output DOUT_{EQ3}(−1) of the 3rd-stage equalizer, and Z₁₄⁻¹ is equal to an output DOUT_{EQ4}(−1) of the 4th-stage equalizer.

The values Z₂₀⁻¹, Z₂₁⁻¹, Z₂₂⁻¹, Z₂₃⁻¹, and Z₂₄⁻¹ are obtained in processing preceding the immediately preceding processing, where Z₂₀⁻¹ is equal to input data DIN(−2), Z₂₁⁻¹ is equal to an output DOUT_{EQ1}(−2) of the 1st-stage equalizer, Z₂₂⁻¹ is equal to an output DOUT_{EQ2}(−2) of the 2nd-stage equalizer, Z₂₃⁻¹ is equal to an output DOUT_{EQ3}(−2) of the 3rd-stage equalizer, and Z₂₄⁻¹ is equal to an output DOUT_{EQ4}(−2) of the 4th-stage equalizer.

Furthermore, multipliers 18, 20, 26, and 28 can successively switch the coefficients multiplied to the set values of the delay circuits. Preferably, the barrel shifters shift the set values two more times at the timing the four-stage filter processing is accomplished, because the contents of the delay circuits can be returned to their initial values. Subsequently, the set values of the delay circuits in the upper barrel shifter can be shifted to the delay circuits in the lower barrel shifter.

As apparent from the foregoing description, the 4-stage filtering processing requires calculations based on input data DIN in the present processing, input data in immediately preceding processing and one more preceding processing, and output DOUT_{EQN} (n=1 to 4) of respective stages calculated in the immediately preceding processing and the one more preceding processing. These data are stored in the barrel shifters that can shift the values in predetermined sequences for the filtering calculations of respective stages.

Upon completion of one round of multistage filter processing including calculations for first to fourth equalizers, the input data in the present processing and the outputs of four stages are input to Z₁₀⁻¹, Z₁₁⁻¹, Z₁₂⁻¹, Z₁₃⁻¹, and Z₁₄⁻¹. Then, the values having been stored in the Z₁₀⁻¹, Z₁₁⁻¹, Z₁₂⁻¹, Z₁₃⁻¹, and Z₁₄⁻¹ are shifted to Z₂₀⁻¹, Z₂₁⁻¹, Z₂₂⁻¹, Z₂₃⁻¹, and Z₂₄⁻¹, respectively.

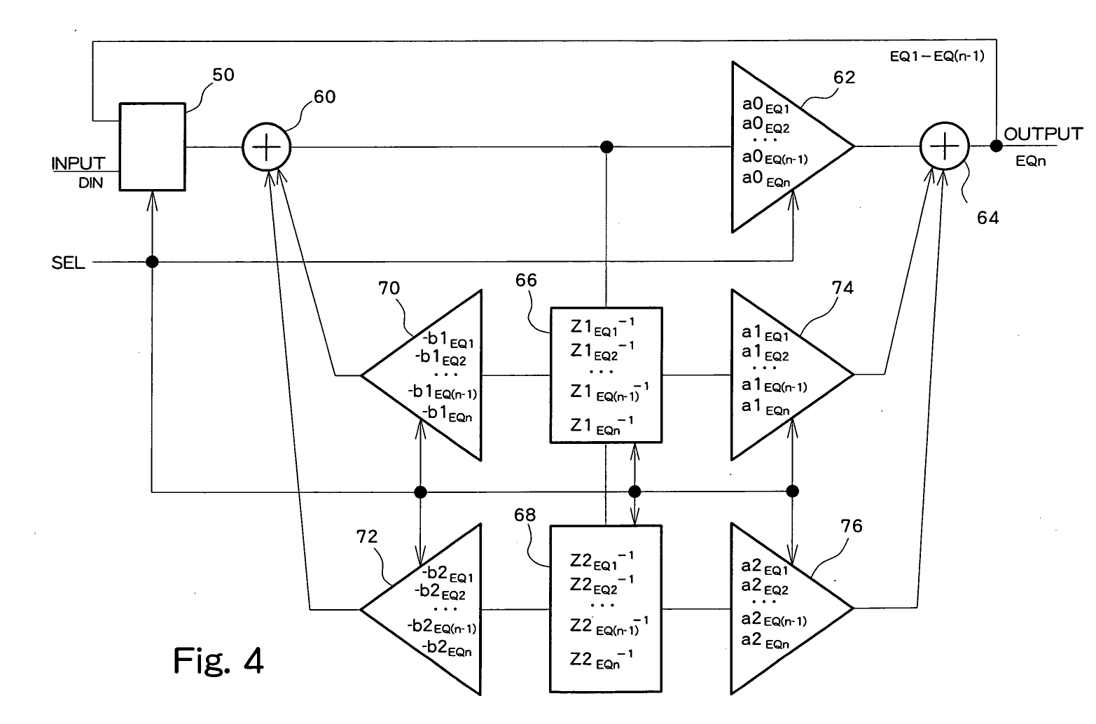

FIG. 4 illustrates another arrangement of a filtering apparatus capable of functioning in the same manner as the circuit illustrated in FIG. 3. According to the arrangement illustrated in FIG. 4, data DIN is input to an adder 60. A multiplier 62 multiplies an output of the adder 60 by a predetermined coefficient. Then, an output of the multiplier 62 is input to an adder 64. The adder 64 produces a filtered output.

A delay circuit 66 receives an output of the adder 60. Another delay circuit 68 receives an output of the delay circuit 66. An output of the delay circuit 66 is returned to the adder 60 via a multiplier 70. Furthermore, an output of the delay circuit 66 is supplied to the adder 64 via a multiplier 74. An output of the delay circuit 68 is returned via a multiplier 72 to the adder 60. Furthermore, an output of the delay circuit 68 is supplied to the adder 64 via a multiplier 76.

The circuit illustrated in FIG. 4 can realize filter processing similar to the processing realized by the circuit illustrated in FIG. 3. As described above, the present embodiment can successively perform filter processing for respective stages by using an output of the adder 64 as an input for succeeding filter processing. In the filter processing for each stage, the present embodiment successively changes the coefficients of the delay circuits 66 and 68 and the multipliers 70, 72, 74, and 76. According to the example illustrated in FIG. 4, a selection signal SEL is supplied to the delay circuits 66 and 68 and the multipliers 70, 72, 74, and 76 to select the coefficients and data.

What is claimed is:

1. A filtering apparatus successively performing multistage filter processing, comprising:
a single-stage filtering section configured to perform a product-sum operation including multiplication operations and addition operations based on variable coefficients set for an input signal, a delay input signal, and a delay output signal;
a coefficient storage section configured to store coefficients used for the filter processing for a plurality of stages; and
an output storage section configured to store a plurality of outputs produced by the filtering section,
wherein
the output storage section supplies an input signal which is equal to an output signal obtained in immediately preceding processing based on previous coefficients, a delayed input signal which is equal to an output signal obtained in processing preceding the immediately preceding processing based on previous coefficients, and a delayed output signal which is equal to an output signal obtained in present processing based on present coefficients,
the coefficient storage section supplies corresponding present coefficients to the filtering section, and
the filtering section successively performs the filter processing for respective stages based on the signals supplied from the output storage section and the coefficients supplied from the coefficient storage section.

2. The filtering apparatus according to claim 1, wherein the filtering section receives an input signal, a 1-clock delayed input signal, a 2-clock delayed input signal, a 1-clock delayed output signal, and a 2-clock delayed output signal from the output storage section, wherein
the input signal is equal to an output signal of 1-clock preceding processing obtained based on immediately previous coefficients, the 1-clock delayed input signal is equal to an output signal of 2-clock preceding processing obtained based on previous coefficients, the 2-clock delayed input signal is equal to an output signal of 3-clock preceding processing obtained based on immediately previous coefficients, the 1-clock delayed output signal is equal to an output signal of 1-clock preceding processing obtained based on present coefficients, and the 2-clock delayed output signal is equal to an output signal of 2-clock preceding processing obtained based on present coefficients.

3. The filtering apparatus according to claim 1, wherein each of the coefficient storage section and the output storage section is formed from a barrel shifter that is capable of successively supplying a set of outputs to the filtering section.
